(19) United States
(12) Patent Application Publication
(10) Pub. No.: US 2014/0192006 A1
(43) Pub. Date: Jul. 10, 2014

(54) TOUCH SENSOR INTEGRATED WITH A LIGHT GUIDE

(71) Applicant: Amazon Technologies, Inc., Reno, NV (US)

(72) Inventors: Lakshman Rathnam, Mountain View, CA (US); Kari Juhani Rinko, Helsinki (FI)

(21) Appl. No.: 13/734,763

(22) Filed: Jan. 4, 2013

(51) Int. Cl. G06F 3/041; G06F 3/044

(52) U.S. Cl. CPC G06F 3/0412; G06F 3/044
USPC 345/174; 349/12; 29/832

(57) ABSTRACT

Various approaches discussed herein provide a display screen that integrates both capacitive touch sensing and a light guide onto a single optically clear substrate. The substrate can be integrated into a portable device, such as an electronic reader (e-reader) device having a reflective display in order to both illuminate content displayed on the e-reader device and to provide touch sensing input to the device. The capacitive sensors can be fabricated on one side of the optically clear substrate, while the light guide can be fabricated on the opposite side of the substrate.

### BACKGROUND

People are increasingly utilizing computers and other electronic devices to access various types of content. For example, users are utilizing portable electronic devices such as electronic book (“e-book”) readers and tablet computers in order to read books, magazines, and view other content. Sometimes these types of devices do not include a backlight for illuminating content, for reasons such as to conserve power and reduce the weight of the devices, as well as to make the content more visible in the presence of bright sunlight. The lack of a backlight, however, might prevent users from being able to utilize these devices at night or in other low light environments, as users might not always be in a situation where it is acceptable or even possible to externally illuminate the device.

### BRIEF DESCRIPTION OF THE DRAWINGS

Various embodiments in accordance with the present disclosure will be described with reference to the drawings, in which:

FIG. 1 illustrates an example situation wherein a user is reading content displayed on a display element of a portable computing device, in accordance with various embodiments;

FIG. 2 illustrates an example of content that might be rendered on a display screen of such a device in accordance with various embodiments;

FIG. 3 illustrates an example of a substrate that integrates capacitive touch sensing and a light guide, in accordance with various embodiments;

FIG. 4 illustrates an example of a light source integrated in the portable computing device, in accordance with various embodiments;

FIG. 5A illustrates an example of a possible structure of an integrated light guide and touch sensor, in accordance with various embodiments;

FIG. 5B illustrates an example of another possible structure of the integrated light guide and touch sensor, in accordance with various embodiments;

FIG. 6A illustrates an example of another possible structure of the integrated light guide and touch sensor, in accordance with various embodiments;

FIG. 6B illustrates an example of another possible structure of the integrated light guide and touch sensor, in accordance with various embodiments;

FIG. 7A illustrates an example of another possible structure of the integrated light guide and touch sensor, in accordance with various embodiments;

FIG. 7B illustrates an example of another possible structure of the integrated light guide and touch sensor, in accordance with various embodiments;

FIG. 8A illustrates an example of another possible structure of the integrated light guide and touch sensor, in accordance with various embodiments;

FIG. 8B illustrates an example of another possible structure of the integrated light guide and touch sensor, in accordance with various embodiments;

FIG. 9A illustrates an example of another possible structure of the integrated light guide and touch sensor, in accordance with various embodiments;

FIG. 9B illustrates an example of another possible structure of the integrated light guide and touch sensor, in accordance with various embodiments;

FIG. 10A illustrates an example of another possible structure of the integrated light guide and touch sensor, in accordance with various embodiments;

FIG. 10B illustrates an example of another possible structure of the integrated light guide and touch sensor, in accordance with various embodiments;

FIG. 11A illustrates an example of a possible structure that includes two substrates with a touch sensor layer, where the optical pattern has been formed directly onto the touch sensors, in accordance with various embodiments;

FIG. 11B illustrates an example of an optical pattern that has been formed directly onto the capacitive touch sensor;

FIG. 12 illustrates an example of a process for manufacturing a substrate that integrates touch sensors with a light guide, in accordance with various embodiments;

FIG. 13 illustrates front and back views of an example portable computing device that can be used in accordance with various embodiments;

FIG. 14 illustrates an example set of basic components of a portable computing device, such as the device described with respect to FIG. 13; and

FIG. 15 illustrates an example of an environment for implementing aspects in accordance with various embodiments.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Systems and methods in accordance with various embodiments of the present disclosure may overcome one or more of the aforementioned and other deficiencies experienced in conventional approaches to providing user interface devices and/or illuminating information displayed on user interface devices. In particular, various approaches discussed herein provide a display screen assembly, or other such display element, that integrates both capacitive touch sensing and a light guide onto a single optically transparent substrate. The substrate can be integrated into a portable device, such as an electronic reader (e-reader) device having a reflective display, in order to both illuminate content displayed on the e-reader device and to provide touch sensing input to the device.

In accordance with an embodiment, the capacitive sensors are fabricated on one side of the optically transparent (e.g., clear) substrate, while the light guide (i.e., optical patterns used to guide the light) is fabricated on the opposite side of the substrate. The capacitive sensors are used to detect touch input from a user. The light guide (e.g., optical patterns) directs light produced by a light source (e.g., LED) onto the reflective display to illuminate the content being displayed on the reflective display. The light guide can be fabricated by applying a lacquer (e.g., ultraviolet lacquer) or other such material on one side of the substrate, such as by using a roll-to-roll or deposition process, and then embossing the light guide (e.g., optical pattern) onto the lacquer. Alternatively, the light guide can be embossed directly onto the substrate, formed into the substrate using a stamping or ablation process, or fabricated into the capacitive sensors, for example. As used herein, the term light guide refers to the optical patterns and other light extraction features that allow the light to be directed out of the substrate. The optical patterns may include printed dots, surface roughening, round shapes, lenses, trapezoidal shapes, ridges, curved surfaces, or any other surface shapes or patterns that cause light diffraction and allow the light to be directed in a desired direction. Such optical patterns may be formed as part of the substrate (molded/stamped), or the patterns can be part of a layer laid down on the substrate (e.g., lacquer, etc.)

On the other side of the substrate (e.g., opposite side from the light guide), the touch sensors can be fabricated to enable touch input for the device. In one embodiment, indium tin oxide (ITO) can be used to construct the touch screen by depositing the ITO onto the side of the substrate and etching the electrode sensors that will be used to detect touch. In another embodiment, the touch sensors may be fabricated out of graphene due to the electrical conductivity and optical transparency of graphene.

In one embodiment, the side containing the touch screen can be facing “up” (i.e. towards the user and away from the reflective display screen) and the side containing the light guide would be facing “down” (i.e. away from the user and towards the reflective display). The sides can also be reversed, such that the touch screen is facing down and the light guide is facing up. It should be understood that directions such as “up” and “down” are used for purposes of explanation and do not require specific orientations unless otherwise stated.

In another embodiment, both the light guide and the touch screen can be fabricated on the same side of the substrate. For example, the optical patterns to guide the light may be formed into the capacitive touch sensors (e.g., electrodes) that also serve to detect touch input. The optical patterns can be formed as part of the same process used to construct the capacitive touch sensor grid and out of the same optical conductive material used to construct the sensors. In one embodiment, the optical pattern can be deposited onto both transmitting sensors (e.g., transmitters) and receiving sensors (e.g., receivers). In other embodiments, the optical pattern can be generated only on the receivers or only on the transmitters.

In accordance with an embodiment, the substrate is optically transparent (e.g., clear) such that light can propagate through the substrate. For example, in certain embodiments, the substrate can have a refractive index of less than 1.45. In various embodiments, the substrate can be a cyclic olefin copolymer, poly(methyl methacrylate) (PMMA), glass, or other optically clear film substrate.

In accordance with an embodiment, one or more light emitting diodes (LEDs) or other light sources are integrated into the electronic device for supplying ambient light to the reflective display. The LEDs can be positioned along the edge of the reflective display or in the corners of the display. The light guide embossed onto one side of the display directs the ambient light emitted by the LEDs onto the reflective display, thereby illuminating the content displayed on the reflective display.

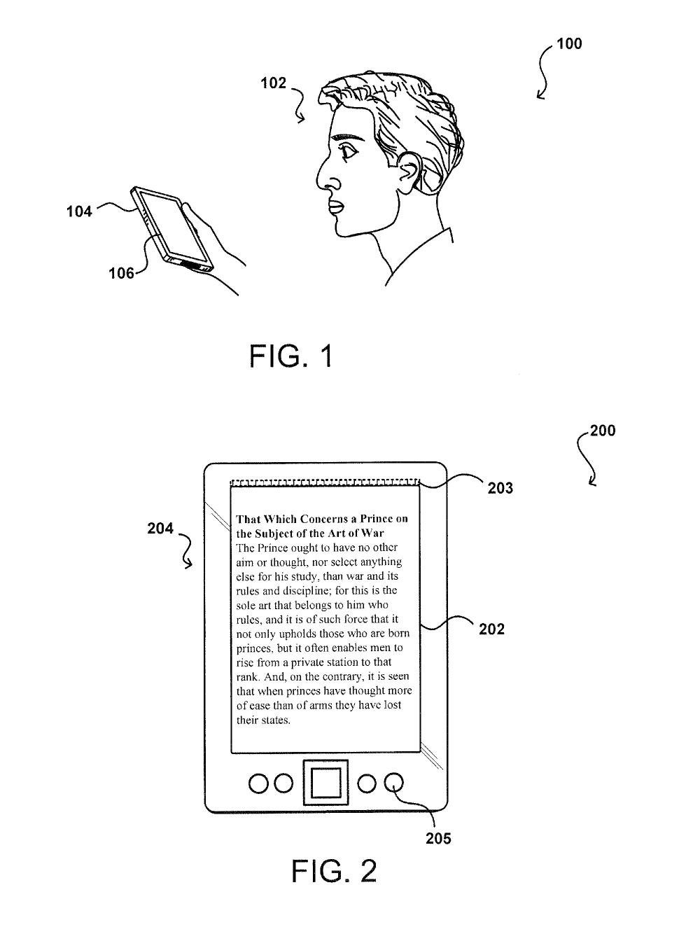

FIG. 1 illustrates an example situation 100 wherein a user 102 is reading content displayed on a display element 106 of a portable computing device 104, in accordance with various embodiments. Although the portable computing device 104 shown is an electronic book reader (e-book) reader, it should be understood that various other types of other electronic devices that are capable of displaying content and processing input can be used in accordance with various embodiments discussed herein. These devices can include, for example, mobile phones, tablet computers, notebook computers, personal data assistants, video gaming consoles or controllers, and portable media players, among others.

FIG. 2 illustrates an example 200 of content that might be rendered on a display screen of such a device 204 in accordance with various embodiments. In this example, the content includes an electronic book (e-book) or other textual content 202 that a user can read when displayed on the display screen. The device further includes a number of buttons 205 that can be used to manipulate the content displayed on the screen (e.g., scroll, move to the next page etc.).

Conventionally, devices such as e-readers have utilized reflective and/or electrophoretic displays to display content, such as the text of an electronic book. This has been advantageous in many aspects, such as allowing users to read under bright sunlight conditions, improving battery life, increasing the portability of the device and the like. For example, many e-readers utilize electronic paper technology which reflects light to display the content (as opposed to conventional backlit panel displays which emit light). Many of these technologies (e.g., gyricon, electrophoretic, electrowetting, electrofluidic, etc.) can hold static text and images indefinitely without using electricity, while allowing images to be changed later, when electricity is applied.

Such reflective displays typically require a certain amount of ambient light in order for the displayed content to be visible to an ordinary user. This means that a light source is needed in order to enable a user to read the device in the dark. In order to deal with this problem, some manufacturers have attempted to incorporate a light source into an e-reader device. For example, in the embodiment shown in FIG. 2, the light source is illustrated as a number of light emitting diodes (LEDs) 203 positioned along the top (or other edge) of the display screen of the device.

At the same time, there is some desire to provide a touch-based user interface for the e-reader, such as a capacitive based touch screen. A touch screen can utilize a number of different approaches to enabling touch input, including but not limited to resistive or capacitive touch based technology. A capacitive touch screen can be a self-capacitance or a mutual-capacitance screen, among other such options.

A self-capacitance screen can include a layer of capacitive material, where in some embodiments, capacitors or capacitive regions are arranged in the layer according to a coordinate system. For example, a plurality of sensor lines (e.g., electrodes) can be arranged in a grid formation having multiple rows and columns (or other formation), where each sensor line is treated as a conductor that has a certain amount of capacitance. When an object (e.g., human finger) comes in proximity or contact with the conductor, the object causes a change in capacitance of the sensor line(s). This capacitive change caused by the object can be measured in the various rows and columns using a current meter (or other such component), enabling the location of the touch to be determined (e.g., by determining the intersection of the affected sensor lines in the grid). For example, the sensor lines can be connected to a touch controller configured to detect the changes in capacitance of the sensors. The self-capacitance approach has relatively low power requirements and produces a relatively strong signal, but in some cases cannot accurately resolve multiple touch locations, especially when more than one or two objects are simultaneously making contact with the screen.

A mutual capacitance based touch screen can utilize the same set of sensor lines or a different set of sensor lines that are configured to act as transmitters and receivers. For example, each column of the sensor grid can be configured as a transmitter that transmits an electrical signal (e.g., produces an electric field) and each row of the sensor grid can be configured as a receiver that receives that electrical signal. When an object such as a finger comes into proximity with the screen, the object causes a change in the amount of signal that the receiver is receiving. For example, the finger touching the screen can reduce the amount of signal being received by the receiver. Based on this change in signal, the location of the touch can be determined. In addition, multiple touches (e.g., 3 or more simultaneous touches) can be accurately located on the touch screen by using mutual capacitance. Thus, while mutual capacitance tends to be more accurate than self-capacitance, mutual capacitance also typically uses more power than self-capacitance (e.g., for transmitting/receiving the electrical signal).

Conventionally, the touch-based screen user interface (e.g., either self-capacitance or mutual capacitance based touch screens) and the front light guide have been manufactured as two separate and independent components. In various embodiments described herein, both the touch screen and the light guide can be incorporated onto a single substrate.

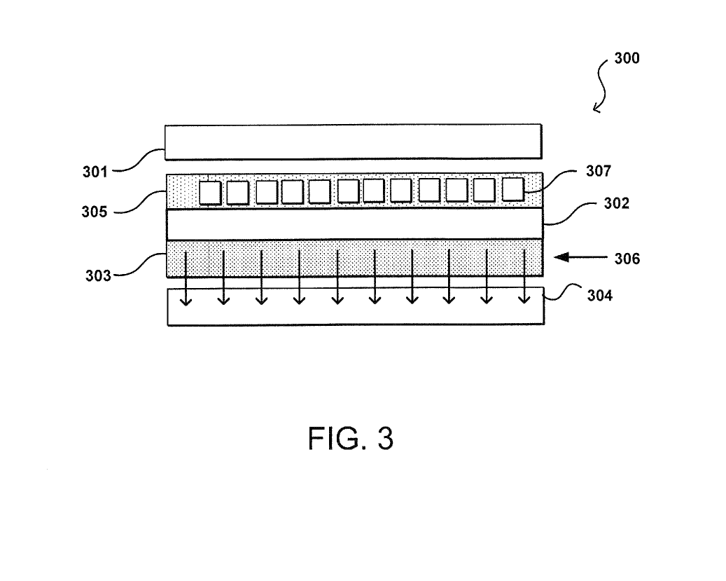

FIG. 3 illustrates an example 300 of a substrate that integrates capacitive touch sensing and a light guide, in accordance with various embodiments. In the illustrated embodiment, various layers of an interface used to present content are shown. For example, an anti-glare layer 301 can be used as the “top” layer of the interface in order to reduce the amount of glare that may be caused by any external light sources (e.g., sun). Underneath the anti-glare layer 301, the interface may include the optically clear substrate 302 that integrates capacitive sensing and a light guide.

In accordance with an embodiment, the substrate 302 can be manufactured in such a way that the front light guide is fabricated on one side 303 of the substrate, while the touch screen 305 is fabricated on the opposite side of the substrate. In another embodiment, both the light guide and the touch screen may be fabricated on the same side of the substrate, as described in other portions of this disclosure. The substrate can be any material that is optically clear, but in some embodiments, it may be advantageous that the substrate has a refractive index below a predetermined threshold (e.g., 1.45). For example, the substrate can be manufactured of PMMA, cyclic olefin copolymer or other clear plastic film.

In accordance with an embodiment, to fabricate a light guide on the first side 303 of the substrate, a lacquer (or other material) can be applied onto the substrate using a process such as a roll-to-roll process, and the light guide can be embossed or otherwise formed or deposited onto the lacquer. Alternatively, the light guide can be embossed directly onto the substrate, without applying any lacquer to it. In another embodiment, the light guide might be formed into the substrate using a stamping or ablation process. In another embodiment, the light guide may be formed onto the capacitive sensors that provide touch sensing. The light guide can include any of a number of patterns that are configured to channel any light 306 (e.g., emitted by an LED), directed into an edge or side of the light guide, in a desired direction, such as onto the reflective display 304, in order to illuminate the content displayed thereon. The pattern can be selected such that the light is directed in a substantially uniform fashion across the reflective display, in order to avoid variations in intensity of the light reflected from different areas of the display.

In accordance with an embodiment, to fabricate the touch sensors 307, ITO, graphene (or other conductive material) can be deposited on the other side 305 of the substrate. The touch sensors 307 can then be formed out of the ITO or graphene.

Graphene is a substance made of pure carbon, with atoms arranged in a regular hexagonal pattern. Usually, graphene is optically more transparent (e.g., has a lower refractive index) than ITO, but not as transparent as optical polymers or glass material. For example, in some cases, the refractive index of graphene has been measured to be between 2.0 and 1.1. In addition, graphene has high intrinsic mobility, high thermal conductivity and its sheet resistance varies over a wide range depending on production methods. Because graphene has a higher transparency and better conductivity than ITO, in some embodiments, graphene may be a good option for a material used to manufacture the capacitive touch sensors.

In various embodiments, the touch sensors can be fabricated onto the substrate by using a number of techniques including but not limited to micro-printing, silk printing masking with vapor deposition, fine inkjet printing, screen printing, photo-etching, dipping the substrate into carbon nano particles or any other methods known in the art.

In accordance with an embodiment, the light guide can be fabricated on the side of the substrate that is facing the reflective display screen 304 which will be used to render the content. The touch sensors, on the other hand, can be fabricated onto the opposite side of the substrate, i.e. the side that is facing the user. In some cases, this configuration can enable the light guide to channel the ambient light more optimally onto the display screen to better illuminate the content, while the touch screen is positioned closer to the user in order to improve the sensing of objects contacting the screen. In alternative embodiments, however, the sides of the substrate can be reversed such that the light guide is positioned to face the user and the touch screen is facing the reflective display, or both the touch sensors and light guide may be placed on the same side of the substrate, as previously described.

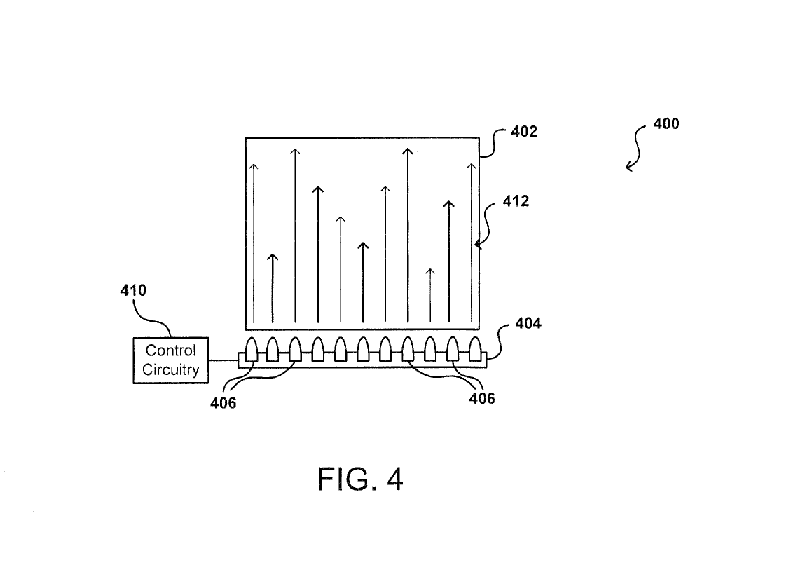

FIG. 4 illustrates a top view 400 of a light source being directed into a display screen and integrated in the portable computing device, in accordance with various embodiments. In the illustrated embodiment, the device includes one or more LEDs 406 and control circuitry 410 operable to control the LEDs. The one or more LEDs can be embedded along the edge of the substrate 402 (e.g., in a bezel). Alternatively, the LEDs may be situated at one or more corners of the screen. The control circuitry 410 can operate the LEDs by turning them off and on in response to various conditions. For example, the control circuitry can be a simple user-activate switch that turns on all the LEDs. Alternatively, the control circuitry may include logic to determine when the environment does not contain enough natural ambient light and turn on the LEDs accordingly. Yet in other embodiments, the control circuitry may activate only a subset of the LEDs or adjust an amount of power supplied to the LEDs when only a small amount of additional light would be sufficient.

In the illustrated embodiment, the light emitted by the LEDs is directed 412 onto the side of the substrate 402 which contains the light guide fabricated thereon. The light guide channels the emitted light onto the reflective display screen, thereby illuminating any content displayed thereon. This can enable a user to read content in the dark or under low lighting conditions.

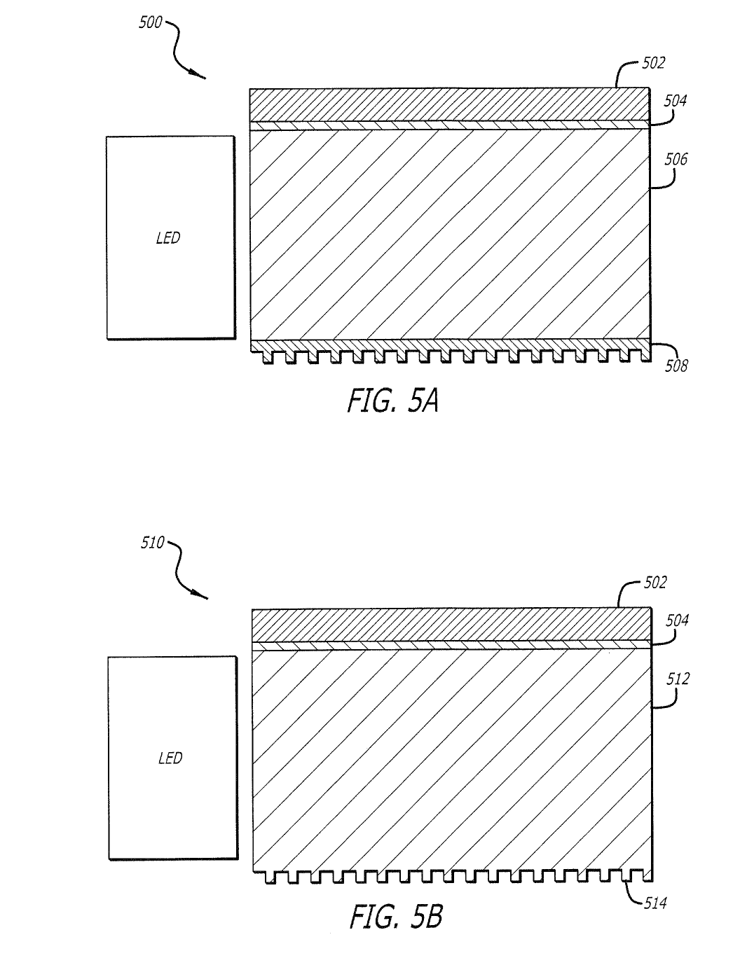

FIG. 5A illustrates an example 500 of a possible structure of an integrated light guide and touch sensor, in accordance with various embodiments. In the illustrated embodiment, the structure includes a capacitive touch sensor layer 502, including both receiving and transmitting conductors (e.g., capacitive sensors) that are used to enable touch input for the device. Underneath the touch sensor layer 502 is a low refractive index coating 504 or other optically clear adhesive (OCA). In various embodiments, the low refractive index coating 504 can be any coating or adhesive that has a refractive index that is lower than the refractive index of the substrate. The thickness of the coating may be on the order of approximately 1 micrometer μm. In the illustrated embodiment, underneath the low refractive index coating 504, is the substrate layer 506 that can be constructed of polymer (e.g., PMMA) or glass material, as previously described. Furthermore, underneath the substrate 506, the structure can include a lacquer layer 508 with an optical pattern formed thereon. The optical patterns direct the light produced by the light emitting diode (LED) onto the surface of the display screen in order to illuminate the content displayed on the screen.

It should be noted that although some examples of this disclosure refer placements such as “underneath” or “on top of”, these terms are used only for purposes of explanation and do not require specific orientations unless otherwise stated.

FIG. 5B illustrates an example 510 of another possible structure of the integrated light guide and touch sensor, in accordance with various embodiments. In this illustrated embodiment, similarly to the embodiment illustrated in FIG. 5A, the structure includes a capacitive touch sensor layer 502, a low refractive index coating 504 and a substrate layer. In this embodiment, however, the substrate layer 512 includes the optical patterns 514 of the light guide formed directly onto the substrate 512. Thus, rather than having a separate lacquer applied (as shown in FIG. 5A), in this embodiment, the light guide is etched directly onto the optically transparent substrate.

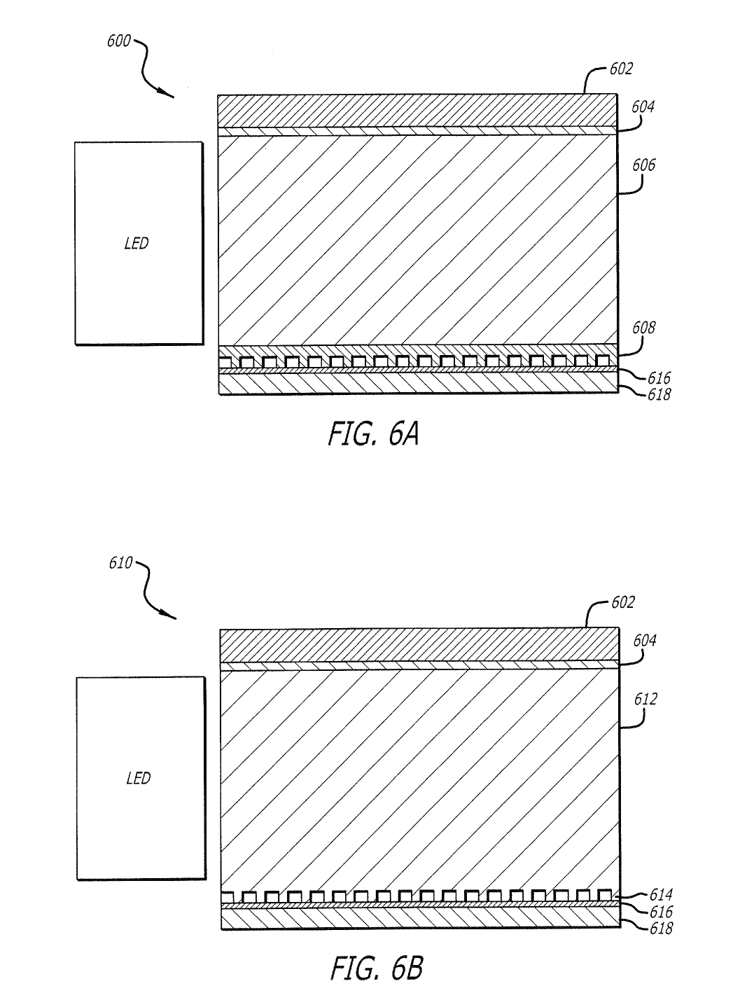

FIG. 6A illustrates an example 600 of another possible structure of the integrated light guide and touch sensor, in accordance with various embodiments. In this illustrated embodiment, the structure includes a touch sensor layer 602 that is comprised of the receiving conductors, a low refractive index coating 604 and a substrate layer 606. Underneath the substrate layer 606 the structure includes a lacquer layer with the optical pattern of the light guide 608. Under the lacquer layer 608, the structure includes a low refractive index coating 616, such as a coating having refractive index lower than the substrate 606. In addition, the structure includes a touch sensor layer 618 that is comprised of the transmitting conductors.

FIG. 6B illustrates an example 610 of another possible structure of the integrated light guide and touch sensor, in accordance with various embodiments. In this illustrated embodiment, similarly to the embodiment shown in FIG. 6A, the structure includes a capacitive touch sensor layer of receiving conductors 602, a low refractive index coating 604 and a substrate layer 612. In this embodiment, however, the optical pattern 614 is formed directly onto the substrate 612. Under the substrate 612, the structure includes a low refractive index coating 616 and a touch sensor layer 618 that is comprised of the transmitting conductors.

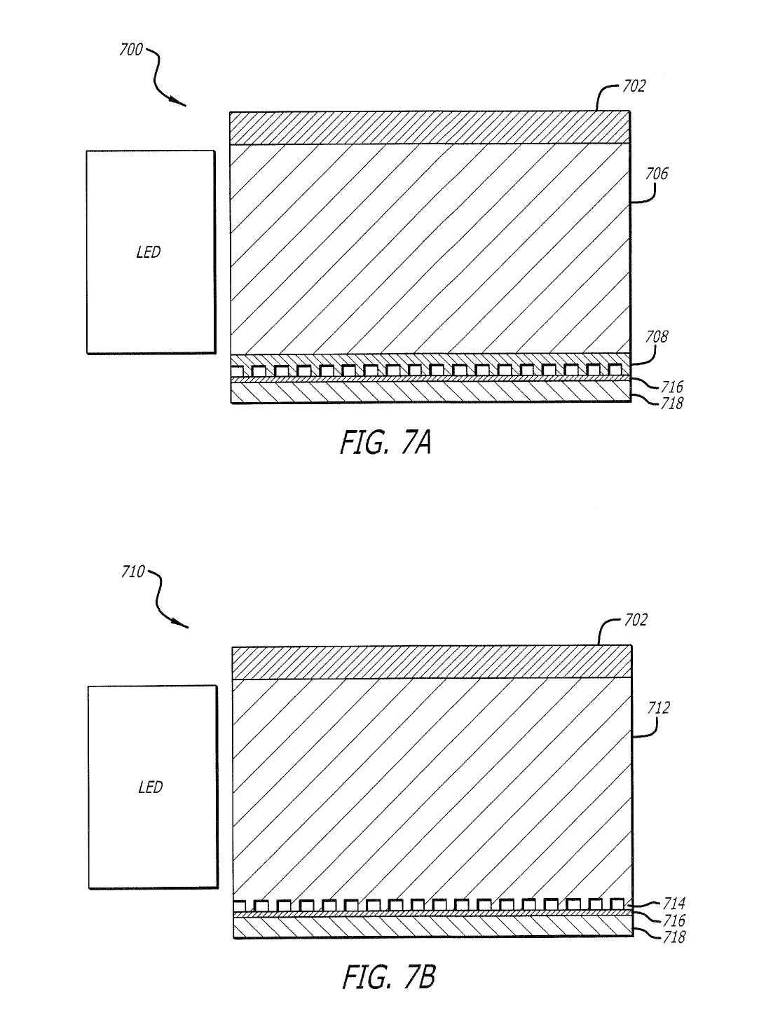

FIG. 7A illustrates an example 700 of another possible structure of the integrated light guide and touch sensor, in accordance with various embodiments. In this illustrated embodiment, the structure includes a touch sensor layer 702 that is comprised of the receiving conductors which are deposited directly onto the substrate layer 706. In contrast to FIG. 6A, the illustrated embodiment does not include a low refractive index coating. In some cases, the coating may be useful to help with the adhesion of the capacitive touch sensors to the substrate. In other cases, the touch sensors can be attached directly to the substrate 706, as illustrated in this embodiment. Underneath the substrate layer 706 the structure includes a lacquer layer with the optical pattern of the light guide 708. Under the lacquer layer 708, the structure includes a low refractive index coating 716, such as a coating having refractive index lower than the substrate 706. In addition, the structure includes a touch sensor layer 718 that is comprised of the transmitting conductors.

FIG. 7B illustrates an example 710 of another possible structure of the integrated light guide and touch sensor, in accordance with various embodiments. In this illustrated embodiment, similarly to the embodiment shown in FIG. 7A, the structure includes a capacitive touch sensor layer of receiving conductors 702 deposited onto the substrate layer 712. In this embodiment, however, the optical pattern 714 is formed directly onto the substrate 712. Under the substrate 712, the structure includes a low refractive index coating 716 and a touch sensor layer 718 that is comprised of the transmitting conductors.

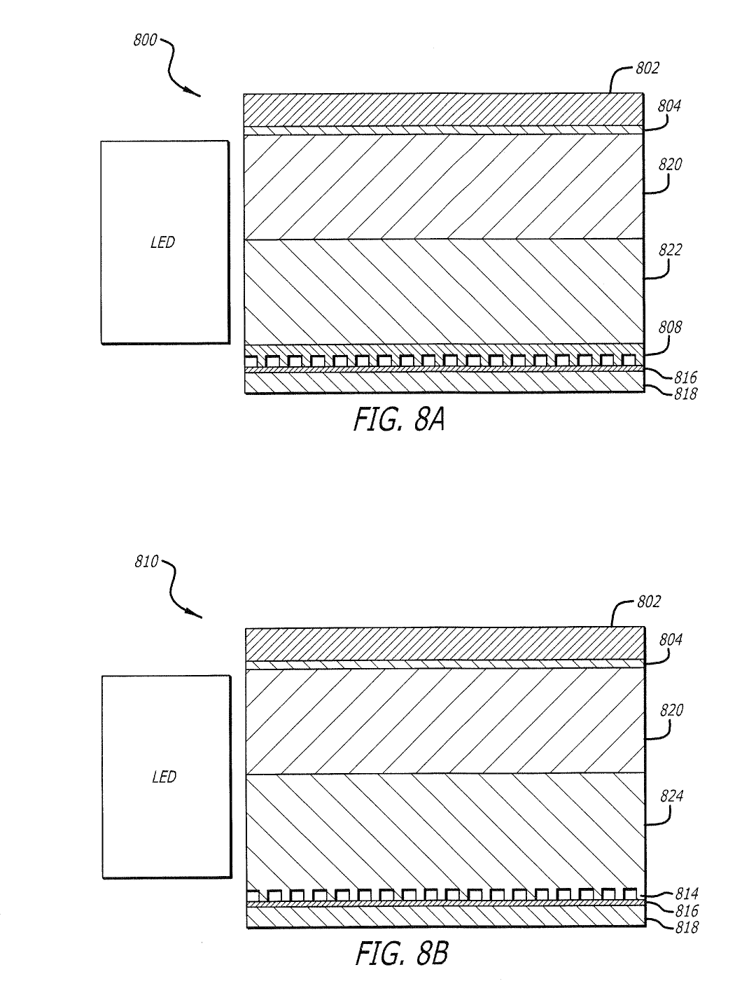

FIG. 8A illustrates an example 800 of another possible structure of the integrated light guide and touch sensor, in accordance with various embodiments. The structure includes a touch sensor layer 802, and a low refractive index coating 804, as previously described. In this embodiment however, the substrate includes two separate substrates (820, 822) fabricated out of polymer (e.g., PMMA), glass or the like. The two substrates 820 and 822 can be adhered together with optical glue. Underneath the two substrates, the structure includes a lacquer layer with the optical pattern of the light guide 808. Under the lacquer layer 808, the structure includes a low refractive index coating 816, such as a coating having refractive index lower than the substrates. In addition, the structure includes a touch sensor layer 818 that is comprised of the transmitting conductors.

FIG. 8B illustrates an example 810 of another possible structure of the integrated light guide and touch sensor, in accordance with various embodiments. In this illustrated embodiment, similarly to the embodiment shown in FIG. 8A, the structure includes a touch sensor layer of receiving conductors 802, and a low refractive index coating 804 on top of a substrate layer 820 of two substrate layers. In this embodiment, however, the optical pattern 814 is formed directly onto the bottom substrate 824 (rather than using a lacquer). Under the substrate 824, the structure includes a low refractive index coating 816 and a touch sensor layer 818 that is comprised of the transmitting conductors.

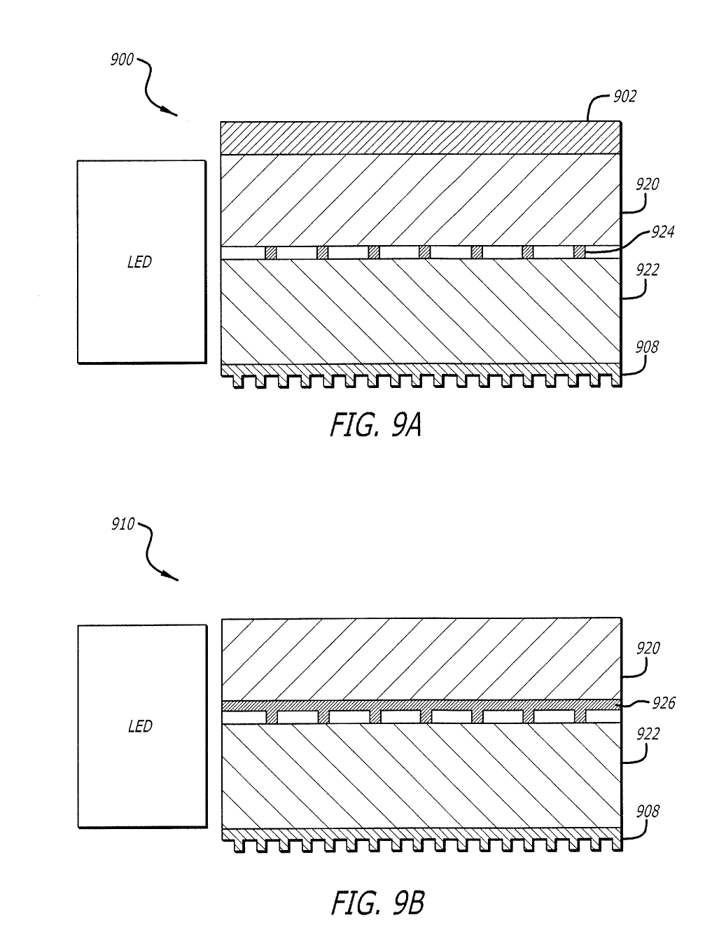

FIG. 9A illustrates an example 900 of another possible structure of the integrated light guide and touch sensor, in accordance with various embodiments. The structure includes a touch sensor layer of receiving conductors 902 directly deposited onto the surface of the top substrate 920. Between the top substrate 920 and the bottom substrate 922, the structure includes a thin touch sensor layer of transmitting conductors 924. In this embodiment, it may be advantageous for the transmitting conductors 924 to have good transparency in order to prevent any light blocking. Underneath the bottom substrate 922, the structure includes a lacquer layer with the optical pattern of the light guide 908, as previously described.

FIG. 9B illustrates an example 910 of another possible structure of the integrated light guide and touch sensor, in accordance with various embodiments. In this illustrated embodiment, the structure includes a top substrate 920 and a bottom substrate 922. Between the top substrate 920 and the bottom substrate 922 the structure includes a touch sensor layer 926 that includes both the transmitting conductors and the receiving conductors. Underneath the bottom substrate 922, the structure includes a lacquer layer with the optical pattern of the light guide 908, as previously described.

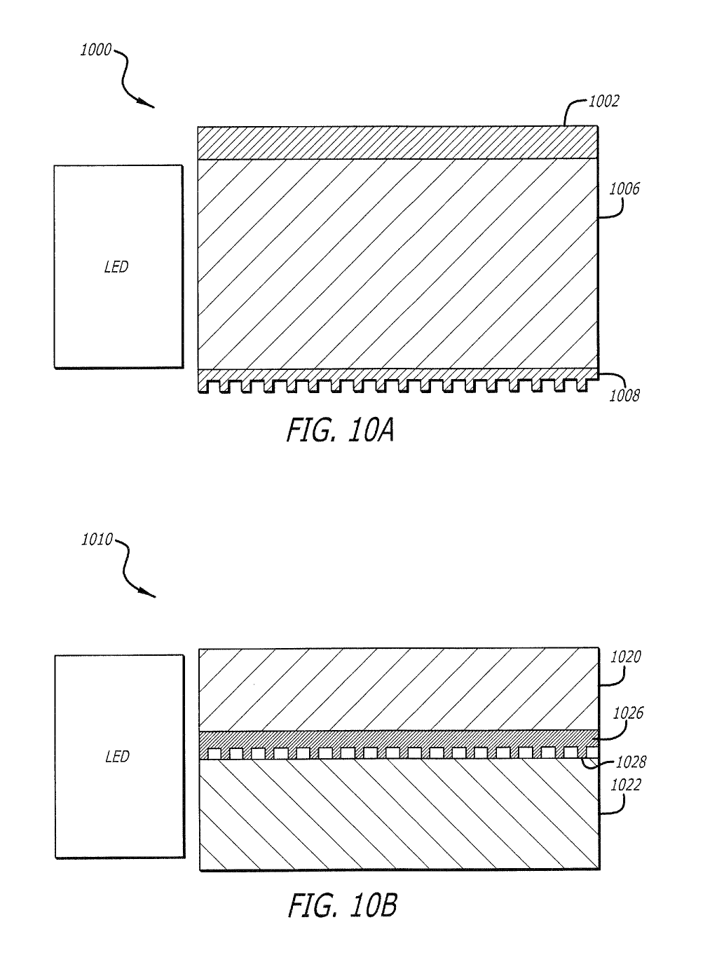

FIG. 10A illustrates an example 1000 of another possible structure of the integrated light guide and touch sensor, in accordance with various embodiments. In the illustrated embodiment, the structure includes a touch sensor layer of receiving conductors 1002 which are deposited directly onto surface of the substrate 1006 (e.g., PMMA, glass material, etc.). Underneath the substrate 1006, the structure includes a touch sensor layer of transmitting conductors 1008, where the optical pattern of the light guide is formed onto the conductors themselves (e.g., aligned on the wire).

FIG. 10B illustrates an example 1010 of another possible structure of the integrated light guide and touch sensor, in accordance with various embodiments. In this illustrated embodiment, the structure includes two substrates 1020 and 1022 (e.g., polymer or glass) that can be adhered together using optical glue. Between the top substrate 1020 and the bottom substrate 1022, the structure includes a thin touch sensor layer 1026 of both receiving and transmitting conductors. In this embodiment, the optical pattern 1028 is formed directly onto the touch sensors (transmitting conductors and receiving conductors) 1026.

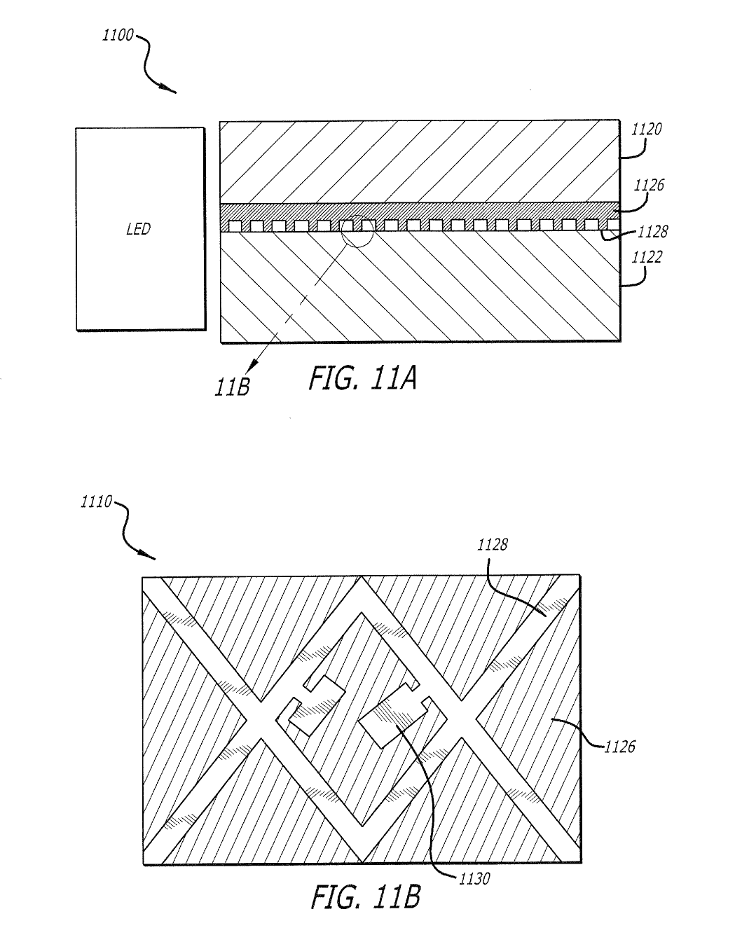

FIGS. 11A and 11B illustrate an example of the optical pattern formed directly onto the capacitive touch sensors, in accordance with various embodiments. FIG. 11A illustrates an example 1100 of a possible structure that includes two substrates 1120 and 1122 with a touch sensor layer 1126 of both receiving and transmitting conductors, where the optical pattern 1128 has been formed directly onto the touch sensors, as previously shown in FIG. 10B. In this example, however, it is shown that the optical pattern formed onto the touch sensors 1126 is illustrated in more detail in FIG. 11B. FIG. 11B thus illustrates an example 1110 of an optical pattern 1128 that has been formed directly onto the capacitive touch sensor layer 1126. The grid of capacitive sensors may further include an optical pattern 1130 in the middle of the grid with a conductivity connection. In this embodiment, the touch sensors serve both functions to detect touch input, as well as to direct the light emitted by the LED onto the surface of the display screen. The optical patterns can be formed as part of the same process as the touch sensor grid and fabricated from the same optical conductive material. In one embodiment, the optical pattern can be generated onto both transmitting and receiving conductors. Alternatively, the optical pattern can be generated on the receiving conductors or the transmitting conductors only.

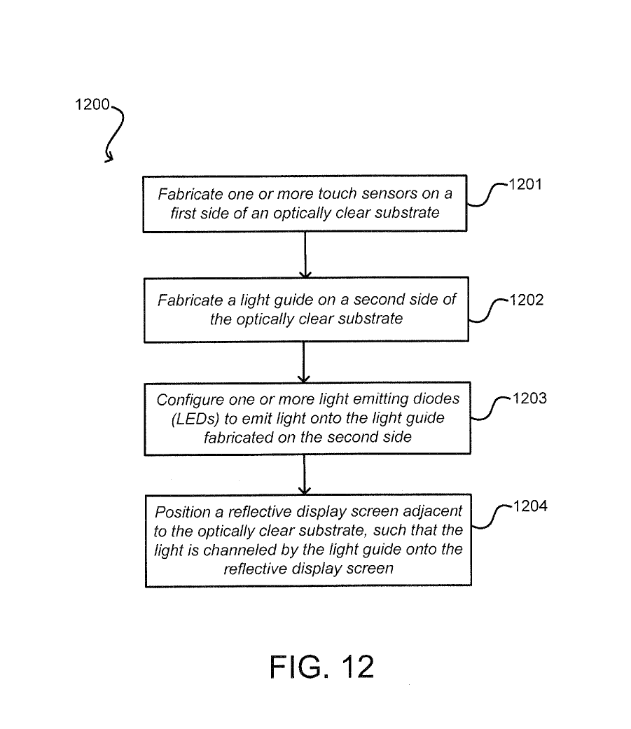

FIG. 12 illustrates an example of a process 1200 for manufacturing a substrate that integrates touch sensors with a light guide, in accordance with various embodiments. Although this figure may depict functional operations in a particular sequence, the processes are not necessarily limited to the particular order or operations illustrated. One skilled in the art will appreciate that the various operations portrayed in this or other figures can be changed, rearranged, performed in parallel or adapted in various ways. Furthermore, it is to be understood that certain operations or sequences of operations can be added to or omitted from the process, without departing from the scope of the various embodiments. In addition, the process illustrations contained herein are intended to demonstrate an idea of the process flow to one of ordinary skill in the art, rather than specifying the actual sequences of code execution, which may be implemented as different flows or sequences, optimized for performance, or otherwise modified in various ways.

In operation 1201, one or more capacitive sensors are fabricated on a first side of an optically transparent substrate. The one or more capacitive sensors can be configured to detect one or more touches. For example, the capacitive sensors may be implemented as a grid of electrode lines, where the rows of the grid act as transmitters and the columns of the grid are configured as receivers. In this configuration, an object touching the screen could be detected based on the intersection of the transmitter and receiver.

In operation 1202, at least one light guide is fabricated on a second side (e.g., opposite side) of the optically transparent substrate. In an alternative embodiment, both the light guide and the capacitive sensors are fabricated on the same side of the substrate, such as by forming the optical pattern of the light guide onto the capacitive sensors. The light guide is configured to direct ambient light to a reflective display screen capable of displaying content.

In operation 1203, one or more light emitting diodes (LEDs) are configured to emit ambient light onto the light guide fabricated on the second side of the substrate. For example, the LEDs can be positioned along the edge of the substrate and can be controlled by a processor to activate/deactivate light based on various conditions.

In operation 1204, a reflective display screen is positioned adjacent to the optically transparent substrate such that the ambient light emitted by the one or more LEDs is used to illuminate the content displayed by the reflective display screen. For example, the light guide contains a pattern that causes the incoming light to be channeled and dispersed on the reflective display. This allows the content displayed on the reflective display to be more clearly visible to a user reading the content.

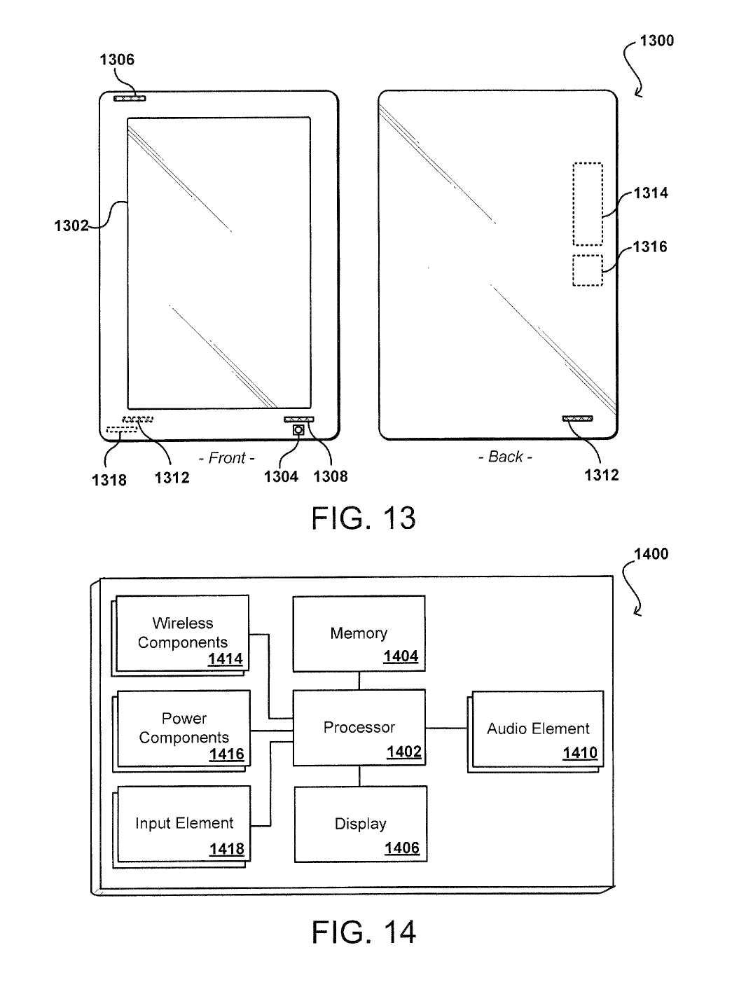

FIG. 13 illustrates front and back views of an example portable computing device 1300 that can be used in accordance with various embodiments. Although an electronic reader device is shown, it should be understood that various other types of electronic devices that are capable of determining, processing, and providing input can be used in accordance with various embodiments discussed herein. The devices can include, for example, tablet computers, cellular phones, notebook computers, personal data assistants, cellular phones, video gaming consoles or controllers, and portable media players, among others.

In this example, the portable computing device 1300 has a display screen 1302 (e.g., a reflective display screen) operable to display images or textual content to one or more users or viewers of the device. In at least some embodiments, the display screen provides for touch or swipe-based input using, for example, capacitive or resistive touch technology. Such a display element can be used to, for example, enable a user to provide input by pressing on an area of the display corresponding to an image of a button, such as a right or left mouse button, touch point, etc. The device can also have touch and/or pressure sensitive material 1310 on other areas of the device as well, such as on the sides or back of the device. While in at least some embodiments a user can provide input by touching or squeezing such a material, in other embodiments the material can be used to detect motion of the device through movement of a patterned surface with respect to the material.

The portable computing device can also include at least one microphone 1306 or other audio capture element capable of capturing audio data, such as may be used to determine changes in position or receive user input in certain embodiments. In some devices there may be only one microphone, while in other devices there might be at least one microphone on each side and/or corner of the device, or in other appropriate locations.

The example device 1300 also includes at least one communication mechanism 1314, such as may include at least one wired or wireless component operable to communicate with one or more portable computing devices. The device also includes a power system 1316, such as may include a battery operable to be recharged through conventional plug-in approaches, or through other approaches such as capacitive charging through proximity with a power mat or other such device. Various other elements and/or combinations are possible as well within the scope of various embodiments.

In order to provide functionality such as that described with respect to FIG. 13, FIG. 14 illustrates an example set of basic components of a portable computing device 1400, such as the device 1300 described with respect to FIG. 13. In this example, the device includes at least one processor 1402 for executing instructions that can be stored in at least one memory device or element 1404. As would be apparent to one of ordinary skill in the art, the device can include many types of memory, data storage or computer-readable storage media, such as a first data storage for program instructions for execution by the processor 1402, the same or separate storage can be used for images or data, a removable storage memory can be available for sharing information with other devices, etc.

The device typically will include some type of display element 1406, such as a touch screen, electronic ink (e-ink), organic light emitting diode (OLED) or liquid crystal display (LCD), although devices such as portable media players might convey information via other means, such as through audio speakers.

The device, in many embodiments, will include at least one audio element 710, such as one or more audio speakers and/or microphones. The microphones may be used to facilitate voice-enabled functions, such as voice recognition, digital recording, etc. The audio speakers may perform audio output. In some embodiments, the audio speaker(s) may reside separately from the device.

The device can include additional input devices that are able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

The example device also includes one or more wireless components 1414 operable to communicate with one or more portable computing devices within a communication range of the particular wireless channel. The wireless channel can be any appropriate channel used to enable devices to communicate wirelessly, such as Bluetooth, cellular, or Wi-Fi channels. It should be understood that the device can have one or more conventional wired communications connections as known in the art. The example device includes various power components 1416 known in the art for providing power to a portable computing device, which can include capacitive charging elements for use with a power pad or similar device as discussed elsewhere herein. The example device also can include at least one touch and/or pressure sensitive element, such as a touch sensitive material around a casing of the device, at least one region capable of providing squeeze-based input to the device, etc. In some embodiments this material can be used to determine motion, such as of the device or a user's finger, for example, while in other embodiments the material will be used to provide specific inputs or commands.

A computing device, in accordance with various embodiments, may include a light-detecting element that is able to determine whether the device is exposed to ambient light or is in relative or complete darkness. Such an element can be beneficial in a number of ways. For example, if the device is determined to be in complete darkness while a user is operating the device, the control circuitry that operates the light source of the device may be configured to turn on the light source in order to illuminate the content displayed on the device. The light-detecting element could also be used in conjunction with information from other elements to adjust the functionality of the device. For example, if the device is unable to detect a user's view location and a user is not holding the device but the device is exposed to ambient light, the device might determine that it has likely been set down by the user and might turn off the display element and disable certain functionality. If the device is unable to detect a user's view location, a user is not holding the device and the device is further not exposed to ambient light, the device might determine that the device has been placed in a bag or other compartment that is likely inaccessible to the user and thus might turn off or disable additional features that might otherwise have been available. In some embodiments, a user must either be looking at the device, holding the device or have the device out in the light in order to activate certain functionality of the device. In other embodiments, the device may include a display element that can operate in different modes, such as reflective (for bright situations) and emissive (for dark situations). Based on the detected light, the device may change modes.

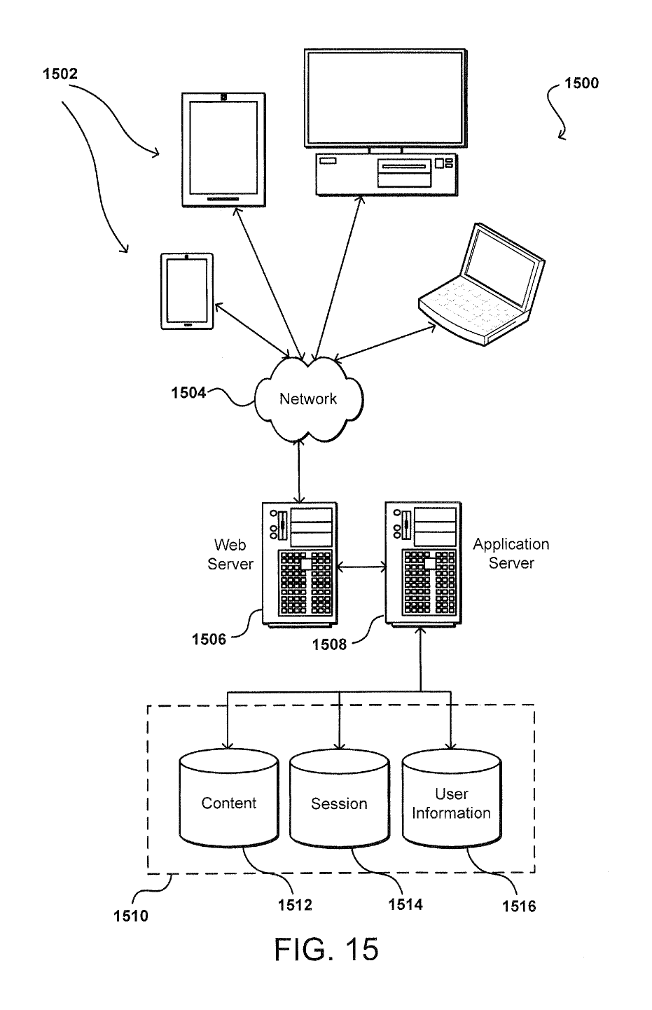

As discussed, different approaches can be implemented in various environments in accordance with the described embodiments. For example, FIG. 15 illustrates an example of an environment 1500 for implementing aspects in accordance with various embodiments. As will be appreciated, although a Web-based environment is used for purposes of explanation, different environments may be used, as appropriate, to implement various embodiments. The system includes an electronic client device 1502, which can include any appropriate device operable to send and receive requests, messages or information over an appropriate network 1504 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. The network could be a “push” network, a “pull” network, or a combination thereof. In a “push” network, one or more of the servers push out data to the client device. In a “pull” network, one or more of the servers send data to the client device upon request for the data by the client device. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1506 for receiving requests and serving content in response thereto, although for other networks, an alternative device serving a similar purpose could be used, as would be apparent to one of ordinary skill in the art.

The illustrative environment includes at least one application server 1508 and a data store 1510. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1508 can include any appropriate hardware and software for integrating with the data store 1510 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1506 in the form of HTML, XML or another appropriate structured language in this example. The handling of all requests and responses, as well as the delivery of content between the client device 1502 and the application server 1508, can be handled by the Web server 1506. It should be understood that the Web and application servers are not required and are merely example components, as structured code discussed herein can be executed on any appropriate device or host machine as discussed elsewhere herein.

The data store 1510 can include several separate data tables, databases or other data storage mechanisms and media for storing data relating to a particular aspect. For example, the data store illustrated includes mechanisms for storing content (e.g., production data) 1512 and user information 1516, which can be used to serve content for the production side. The data store is also shown to include a mechanism for storing log or session data 1514. It should be understood that there can be many other aspects that may need to be stored in the data store, such as page image information and access rights information, which can be stored in any of the above listed mechanisms as appropriate or in additional mechanisms in the data store 1510. The data store 1510 is operable, through logic associated therewith, to receive instructions from the application server 1508 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1502. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 15. Thus, the depiction of the system 1500 in FIG. 15 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Pert, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computing device, comprising:
a memory storing content;
one or more processors configured to process the content stored in the memory; and
a touch screen assembly for displaying the content processed by the one or more processors, the touch screen assembly including:
a reflective display configured to display the content;
a light source configured to emit light; and
an optically transparent substrate positioned adjacent to the reflective display and oriented to receive the light from the light source into at least one edge of the optically transparent substrate, the optically transparent substrate having a first side and a second side,
the first side of the optically transparent substrate including a plurality of capacitive sensors formed thereon, the capacitive sensors configured to detect touch input,
the second side of the optically transparent substrate having one or more optical patterns formed thereon, the optical patterns configured to direct the received light from the light source onto the reflective display to illuminate the content being displayed on the reflective display.

2. The computing device of claim 1, wherein the second side of the optically transparent substrate is adjacent to the reflective display.

3. The computing device of claim 1, wherein the touch screen assembly further includes:
an anti-glare layer positioned adjacent to the optically transparent substrate the anti-glare layer configured to reduce reflection on the touch screen assembly.

4. The computing device of claim 1, wherein the optical patterns include one or more of: printed dots, surface roughening, round shapes, lenses, trapezoidal shapes, lines, ridges, or curved surfaces; and
wherein the optical patterns are formed directly on the second side of the optically transparent substrate or formed on a layer that is deposited onto the second side of the optically transparent substrate.

5. A device, comprising:
a display screen configured to display content;
at least one light source; and
a substrate positioned proximate to the display screen, the substrate having a plurality of sensors fabricated on a first side of the substrate, the sensors configured to provide touch sensing capability for the device, the substrate further having one or more optical patterns fabricated on a second side that is opposite with respect to the first side,
wherein the one or more optical patterns is configured to direct light from the at least one light source onto the display screen so as to be reflected from the display screen, in order to illuminate the content being displayed on the display screen.

6. The device of claim 5 herein the plurality of sensors includes a plurality of electrodes for detecting changes in at least one of: capacitance or electrical field caused by one or more objects in proximity to the device.

7. The device of claim 5, wherein the at least one light source further includes:
one or more light emitting diodes (LEDs) positioned along at least one edge of the substrate, the one or more LEDs emitting the light used to illuminate the content being displayed on the display screen.

8. The device of claim 5, wherein the substrate is at least one of: a cyclic olefin copolymer, a poly(methyl methacrylate) (PMMA), or glass.

9. The device of claim 5, wherein the substrate has a refractive index that is lower than 1.45.

10. The device of claim 5, wherein the plurality of sensors are fabricated out of at least one of: indium tin oxide (ITO) or graphene.

11. The device of claim 10, wherein the plurality of sensors are fabricated onto the first side of the substrate by performing at least one of: micro printing, silk printing, etching, or depositing the at least one of: ITO or graphene onto the first side of the substrate.

12. The device of claim 5, further comprising: an ultraviolet (UV) lacquer deposited onto the second side of the substrate, the UV lacquer including the one or more optical patterns that cause ambient light to be directed in a particular direction.

13. The device of claim 5, wherein the display screen further includes at least one of: a reflective display, an electrophoretic display, an electronic paper display, an electrowetting display, or an electrofluidic display.

14. The device of claim 5, further comprising:
an anti-reflective layer positioned adjacent to the substrate, the anti-reflective layer configured to reduce reflection on the display screen.

15. The device of claim 5, wherein the second side of the substrate is adjacent to the display screen.

16. The device of claim 5, further comprising:
memory configured to store the content; and
one or more processors configured to process the content and display the content on the display screen.

17. A device comprising:
a display screen configured to display content;
a light source;
a substrate having a surface, the surface including one or more capacitive touch sensors and one or more optical patterns formed onto the one or more capacitive sensors, the one or more optical patterns directing light produced by the light source onto the display screen to illuminate the content being displayed on the display screen.

18. The device of claim 17, wherein the one or more capacitive sensors are fabricated out of at least one of: graphene or indium tin oxide (ITO).

19. A method for fabricating a touch screen display, the method comprising:
fabricating one or more capacitive sensors on a first side of an optically transparent substrate, the one or more capacitive sensors configured to detect one or more touches;
forming one or more optical patterns on a second side of the optically transparent substrate, the one or more optical patterns configured to direct ambient light to a reflective display screen capable of displaying content;
configuring one or more light emitting diodes (LEDs) to emit the ambient light to the optically transparent substrate; and
positioning the reflective display screen adjacent to the optically transparent substrate such that the ambient light emitted by the one or more LEDs is used to illuminate the content displayed by the reflective display screen.

20. The method of claim 19, wherein fabricating the one or more sensors on the first side of the optically clear substrate further includes performing at least one of: micro printing, silk printing, etching, or depositing indium tin oxide (ITO) onto the first side of the substrate.

21. The method of claim 19, wherein fabricating the at least one light guide on the second side of the optically clear substrate further includes:
embossing, onto the second side, an ultraviolet (UV) lacquer with a pattern that causes ambient light to be directed in a particular direction.

22. The method of claim 19, further comprising:
fabricating an anti-reflective layer and positioning the anti-reflective layer adjacent to the substrate, the anti-reflective layer configured to reduce reflection on the display screen.

23. The method of claim 19, further comprising:
integrating the optically clear substrate into an electronic reader (e-reader) device.

24. A computer implemented method for displaying content, the method comprising:
under control of at least one computing device configured with executable instructions,
displaying content on a touch screen interface that includes a reflective display and an optically clear substrate, the optically clear substrate including:
a first side having a plurality of sensors deposited thereon, the sensors configured to provide touch sensing input; and
a second side having one or more optical patterns deposited thereon, the one or more optical patterns configured to direct light onto the reflective display screen; and
supplying ambient light to the optically clear substrate to illuminate the content displayed on the reflective display.

25. The computer implemented method of claim 24, wherein supplying the ambient light further includes:
supplying power to one or more light emitting diodes (LEDs) positioned along at least one edge of the optically clear substrate, the one or more LEDs configured to emit the ambient light used to illuminate the content being displayed on the reflective display screen.

26. The computer implemented method of claim 24, wherein the substrate is at least one of: a cyclic olefin copolymer, a poly(methyl methacrylate) (PMMA), or glass.

27. The computer implemented method of claim 24, wherein the substrate has a refractive index that is lower than 1.45.

28. The computer implemented method of claim 24, wherein the reflective display is capable of statically holding a displayed image or text without electricity supplied to the reflective display.
